(19) United States
(12) Patent Application Publication
(10) Pub. No.: US 2005/0177535 A1
(43) Pub. Date: Aug. 11, 2005

(54) Business process autonomy improving system and method

(76) Inventor: WenZhou Song, Tokyo (JP)

Correspondence Address: BROOKS KUSHMAN P.C., 1000 TOWN CENTER, TWENTY-SECOND FLOOR, SOUTHFIELD, MI, 48075, US

(21) Appl. No.: 10/514,293

(22) PCT Filed: May 14, 2003
(86) PCT No.: PCT/JP03/05995

(51) Int. Cl. G06F 7/00

(52) U.S. Cl. 707/1

(57) ABSTRACT

The object is to provide a system and a method for autonomously improving the business process, in which the business activities are analyzed based on the business report submitted by responsible employees of an enterprise to support the business activities of the responsible employees. The data can be transmitted and received between a responsible employee's terminal and a superior's terminal through a network. The system comprises a communication sheet setting means for causing the superior's terminal and/or the responsible employee's terminal to set the business report items in the communication sheet displayed on the responsible employee's terminal, and registering the business report items in a communication sheet data base, and a communication sheet registration means for displaying the communication sheet on the responsible employee's terminal, receiving the business report from the responsible employee's terminal and registering it in the communication sheet data base.

### TECHNICAL FIELD

The present invention relates to a system and method for autonomously improving a business process, wherein the business activities are analyzed based on the business report submitted by a responsible employee of an enterprise to support the business activities of the responsible employee.

### BACKGROUND ART

A responsible employee who has conducted a business activity (such as a sales activity) is generally required to prepare a business report of his/her business activities. The business report submitted by the responsible employee is checked by his/her superior, who gives the responsible employee an instruction on the next business activities thereby to improve the business activities.

However, to prepare each time a business report of the business activity is a bothersome job, and since this process has yet to be computerized, the business report cannot be analyzed and utilized effectively.

In view of this problem, Japanese Patent Laid-open (JP-A) No. 2002-99708 discloses an invention in which the sales report on the insurance sales activities is managed by being computerized to grasp the sales activities systematically and objectively.

According to the invention disclosed in JP-A 2002-99708, the salesman inputs predetermined items (say, the date, the customer code and the specifics of the activity) after his/her sales activity, so that the sales achievement and the sales plan are output as a daily sales record similar to the conventional one at a predetermined time.

The invention of JP-A 2002-99708, however, is nothing but a computerization of the conventional daily sales record. The sales report input by the salesman, therefore, is required to be analyzed in some way or another by his/her superior through the process of check and comparison. Further, in view of the fact that the report by the salesman is limited to predetermined items, the differences of the business activities between a successful salesman and those of an unsuccessful salesman cannot be easily clarified based on the daily sales record.

Specifically, it is unknown how the successful salesman is conducting his/her sales activities, how the sales activities of the successful salesman are different from those of the unsuccessful salesman, and in what way the unsuccessful salesman is required to conduct his/her sales activities to secure a high sales achievement.

### DISCLOSURE OF THE INVENTION

In view of the problematic points described above, according to this invention, there is provided a system for autonomously improving a business process, wherein the business report including the sales report is not simply computerized but the report items (hereinafter referred to as “the business report items”) in the business report to be submitted by all of the responsible employees are dynamically changed in accordance with the business activities of successful employees.

Changing the business report items leads to the requirement on the part of each responsible employee to conduct the business activities conforming with the business report items, and therefore the business activities of all of the responsible employees come to be converged on the business activities of the successful employees.

Further, by standardizing the report items of the business report in the form of a pull-down menu or a check list, the specifics of the business activities can be digitized, and automatic analysis is made possible in selectively determining the report items.

According to claim 1, there is provided a system for autonomously improving a business process to support the business activities of a responsible employee, comprising: a communication sheet setting means for transmitting and receiving data between a responsible employee's terminal owned by the responsible employee and a superior's terminal owned by the superior through a network, causing the superior's terminal and/or the responsible employee's terminal to set the business report items in the communication sheet displayed at the responsible employee's terminal, and registering the business report items in a communication sheet data base; and a communication sheet registration means for displaying the communication sheet at the responsible employee's terminal, receiving the business report from the responsible employee's terminal and registering the business report in the communication sheet data base.

According to claim 2, there is provided a system for autonomously improving a business process, wherein the communication sheet setting means is adapted to set at least one of the business process, the specifics of the business activities, the business report item, the business type and the business report item to be displayed for each business process of each business type.

According to claim 8, there is provided a method for autonomously improving a business process to support the business activities of a responsible employee, wherein data can be transmitted and received between a responsible employee's terminal owned by the responsible employee and a superior's terminal owned by the superior through a network, and the business report items in the communication sheet displayed at the responsible employee's terminal are set from the superior's terminal and/or the responsible employee's terminal and registered in the communication sheet data base, and wherein the communication sheet is displayed at the responsible employee's terminal and the business report is received from the responsible employee's terminal and registered in the communication sheet data base.

According to claim 9, there is provided a method for autonomously improving a business process, wherein the communication sheet setting means is adapted to set at least one or all of the business process, the specifics of the business activities, the business report item, the business type and the business report item to be displayed for each business process of each business type.

In the invention according to claims 1, 2, 8 and 9, the business report is input by the responsible employee not always from the same communication sheet, but unlike in the prior art, from the communication sheet with the business report items thereof being dynamically changed.

According to claim 3, there is provided a system for autonomously improving a business process, further comprising an analysis means for analyzing the responsible employee or all or an arbitrary one of the groups conducting the business based on the business report registered in the communication sheet data base.

According to claim 10, there is provided a method for autonomously improving a business process, wherein the responsible employee or all or an arbitrary one of the groups conducting the business based on the business report registered in the communication sheet data base is analyzed.

In the invention according to claims 3 and 10, analysis is made possible between all the groups (company), an arbitrary group (department or section to which the responsible employee belongs, for example) and the responsible employee conducting the business. As a result, the superior can easily determine what kind of business report items of the report the superior should require from or urge the responsible employee to submit. Thus, the business report items can also be set easily in the communication sheet.

According to claim 4, there is provided a system for autonomously improving a business process, further comprising a rule making means for analyzing the business pattern based on the registered business report and making and registering a rule.

According to claim 11, there is provided a method for autonomously improving a business process, wherein the business pattern is analyzed based on the registered business report thereby to make and register a rule.

In the invention according to claims 4 and 11, the responsible employee departing from a successful business pattern or proximate to a failure pattern is automatically notified how he/she can approach the successful business pattern.

According to claim 5, there is provided a system for autonomously improving a business process, further comprising a temporal restriction registration means for receiving the temporal restriction of the business report from the responsible employee's terminal and/or the superior's terminal and registering it in a rule data base.

According to claim 6, there is provided a system for autonomously improving a business process, further comprising a rule check means for checking the business report registered in the communication sheet data base according to the rule registered in the rule data base, and in the case where certain conditions are met, notifying the responsible employee's terminal and/or the superior's terminal.

According to claim 12, there is provided a method for autonomously improving a business process, wherein the temporal restriction of the business report is received from the responsible employee's terminal and/or the superior's terminal and registered in a rule data base.

According to claim 13, there is provided a method for autonomously improving a business process, wherein the business report registered in the communication sheet data base is checked with the rule registered in the rule data base, and in the case where certain conditions are met, the responsible employee's terminal and/or the superior's terminal is notified.

In the invention according to claims 5, 6, 12 and 13, the responsible employee and the superior are prevented from forgetting the temporal restriction of the business report (the business report is required to be registered by a given time, for example).

According to claim 7, there is provided a system for autonomously improving a business process, wherein the communication sheet or the business report items are set for each business type of the business activities and each business process of the business type.

According to claim 14, there is provided a method for autonomously improving a business process, wherein the communication sheet or the business report items are set for each business type of the business activities and each business process of the business type.

### BRIEF DESCRIPTION OF THE DRAWINGS

FIG. 1 is a diagram showing an example of a system configuration according to this invention;

FIG. 2 is a flowchart showing an example of a process flow according to the invention;

FIG. 3 is a flowchart showing an example of a process flow according to the invention;

FIG. 4 is a schematic diagram showing the relation between the business type and the business process;

FIG. 5 shows an example of an analysis screen based on a scatter diagram;

FIG. 6 shows an example of the analysis screen based on a radar chart;

FIG. 7 is a schematic diagram showing the approach to a correct business process;

FIG. 8 shows an example of a master management screen;

FIG. 9 shows an example of a business report item list screen;

FIG. 10 shows an example of a pull-down menu customized screen;

FIG. 11 shows an example of a communication sheet item display select screen;

FIG. 12 shows an example of a communication sheet item detail setting screen;

FIG. 13 shows an example of a communication sheet;

FIG. 14 shows an example of a communication sheet for a mobile phone having the network function;

FIG. 15 is a flowchart showing an example of the process flow for the analysis means to make a rule;

FIG. 16 shows an example of a reminder setting screen;

FIG. 17 is a flowchart showing an example of the process flow for registering the temporal restriction;

FIG. 18 shows an example of sentences restored;

FIG. 19 shows an example of the screen displaying a potential;

FIG. 20 shows an example of the screen showing the specific activities in a radar chart; and

FIG. 21 shows an example of the business process registration screen.

### DESCRIPTION OF REFERENCE NUMERALS

1: System for autonomously improving business process
2: Employee registration means
3: Communication sheet setting means
4: Temporal restriction registration means
5: Analysis means
6: Communication sheet registration means
7: Rule check means
8: Employee data base
9: Rule data base
10: Communication sheet data base
11: Employee's terminal
12: Superior's terminal
13: Network

### BEST MODE FOR CARRYING OUT THE INVENTION

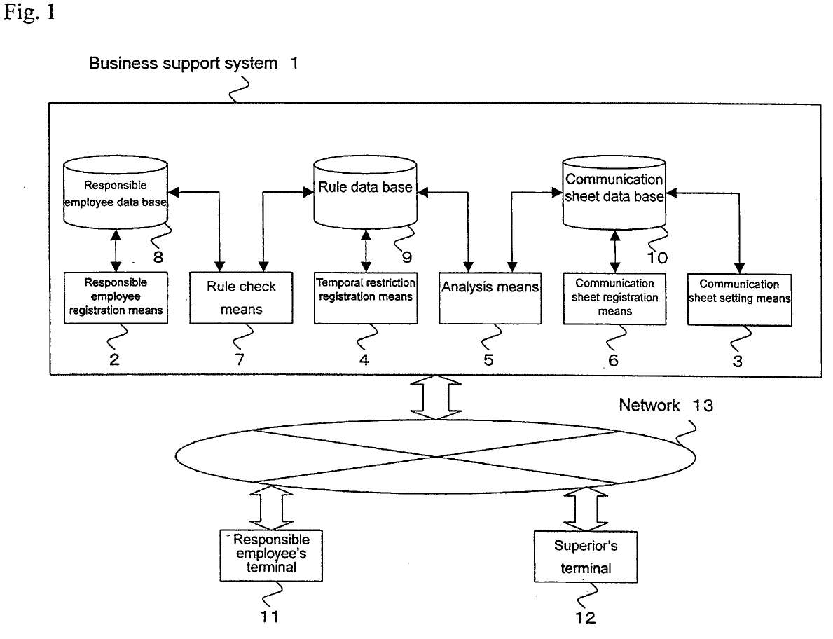

An example of the system configuration according to the invention is shown in the system configuration diagram of FIG. 1. In a system 1 for autonomously improving the business process, data can be transmitted and received between a responsible employee's terminal 11 of a responsible employee and a superior's terminal 12 of a superior supervising the duties of the responsible employee, or a consultant (hereinafter referred to as the “superior”) through a network 13.

The business process autonomous improvement system 1 comprises a responsible employee registration means 2, a communication sheet setting means 3, a temporal restriction registration means 4, a communication sheet registration means 6, a rule check means 7, an analysis means 5, a responsible employee data base 8, a rule data base 9 and a communication sheet data base 10.

The responsible employee registration means 2 receives the information on the responsible employee (responsible employee's information) from the superior's terminal 12 or the responsible employee's terminal 11 and registers it in the responsible employee data base 8. In the process, the name, the responsible employee's code, the department, the department code, the electronic mail address, etc. of the responsible employee are preferably registered as the responsible employee's information.

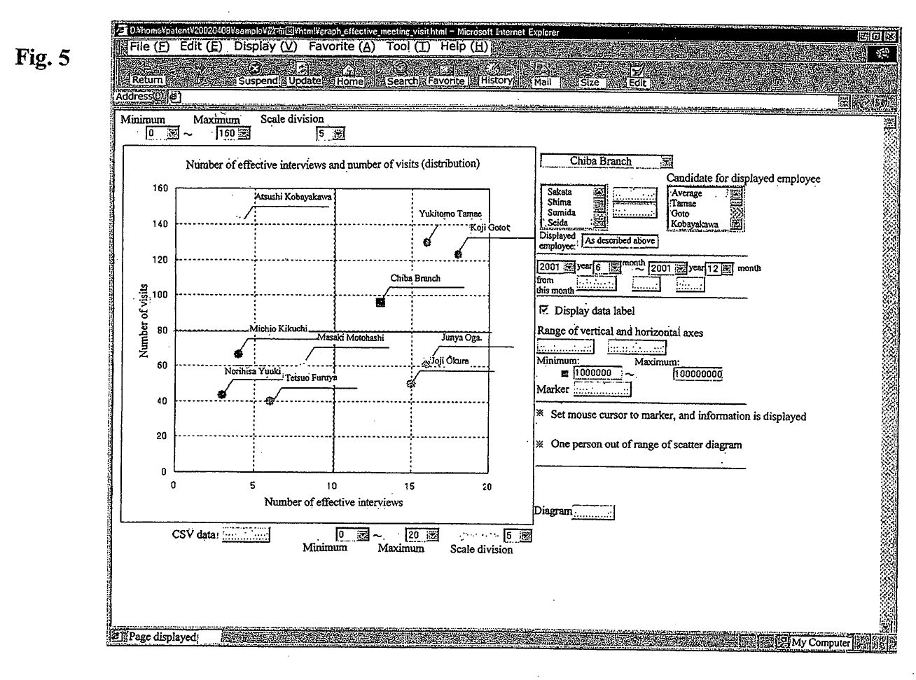

The communication sheet setting means 3 determines the business report items to be displayed in the communication sheet and reported to the responsible employee for registration. The business report items are preferably set in a matrix as a business process for each business type. The business type is defined as the type and method of the work of each responsible employee including the market development, the route sales, the maintenance service, the outbound communication, the inbound communication and the Web inquiry. The business process, on the other hand, includes each business type classified in temporal phases, such as the DM (direct mail), interview, visit, demonstration, hearing, proposition, sales promotion, budget, contract signing, delivery, maintenance, etc., as shown in the schematic diagram of FIG. 4.

Specifically, different business report items (which of course may include the same item) are set with a communication sheet in all the elements of the matrix. The communication sheet setting means 3, therefore, sets the business process (all items handled company wide in temporal phases classified), the specific activities of the responsible employee, the business report items, the business type of the responsible employee and the business report item to be displayed in each business process of each business type, all of which are displayed at the responsible employee's terminal 11.

The business report item first to be prepared is preferably set by the superior of the responsible employee from the superior's terminal 12.

The temporal restriction registration means 4 receives the temporal restriction of the responsible employee from the responsible employee's terminal 11 or the superior's terminal 12, and registers it in the rule data base 9. The temporal restriction such as the time limit of registration of a business report item, for example, is registered by the responsible employee himself. Also, the temporal restriction is registered in terms of a time limit imposed by the superior on all of the responsible employees for registration of a predetermined business report item.

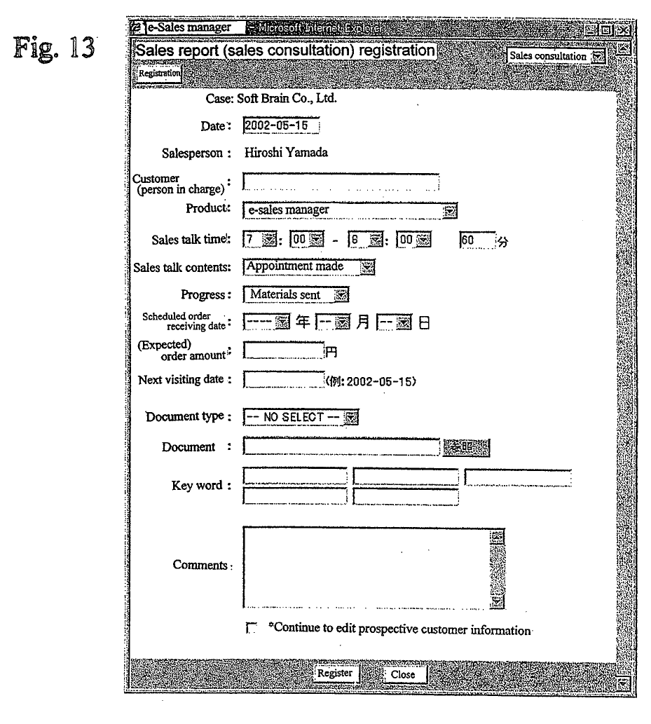

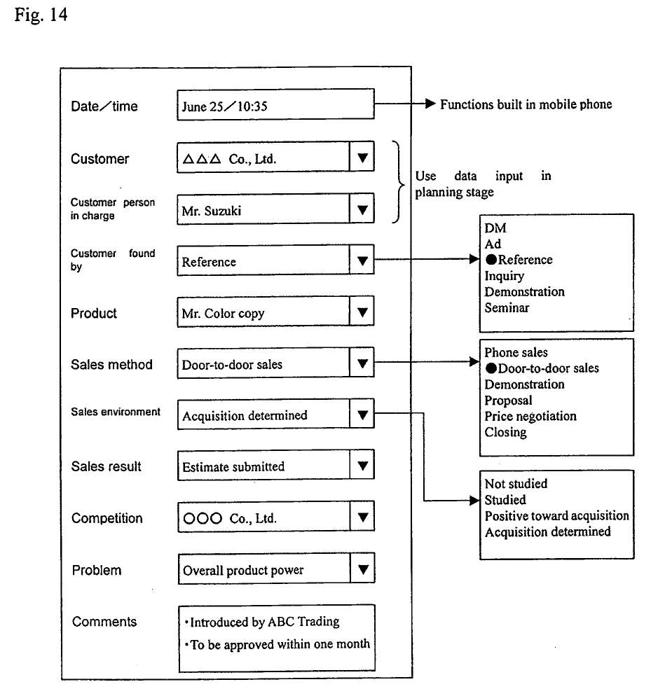

The communication registration means 6 receives a business report item displayed in the communication sheet of the responsible employee's terminal 11 from the responsible employee's terminal 11, and registers it in the communication data base 10. FIGS. 13 and 14 show an example of the communication sheet.

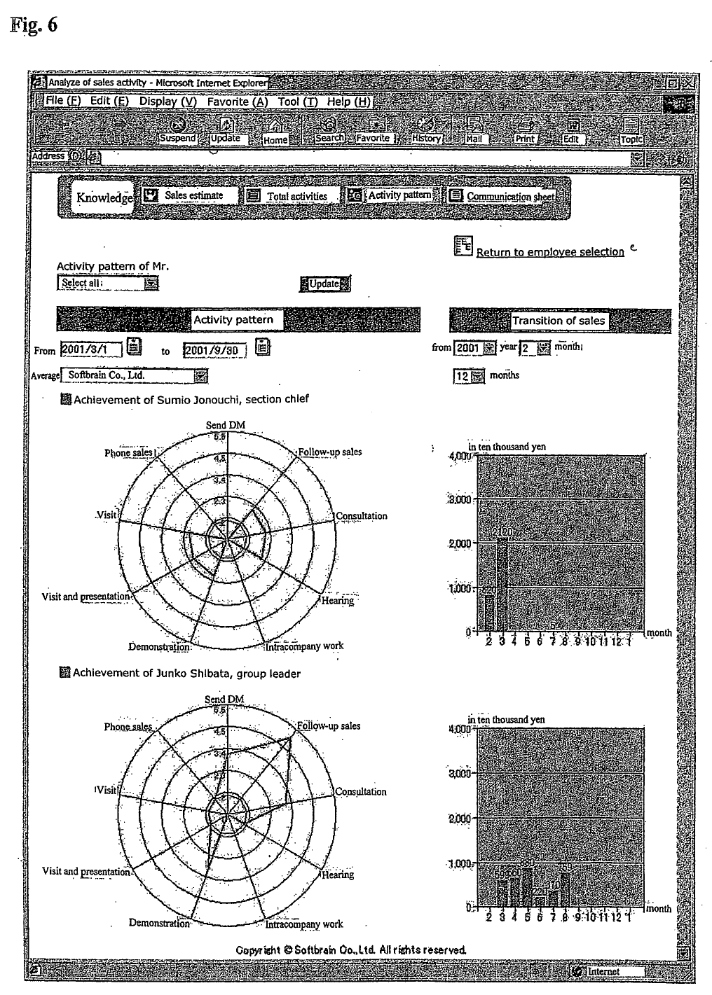

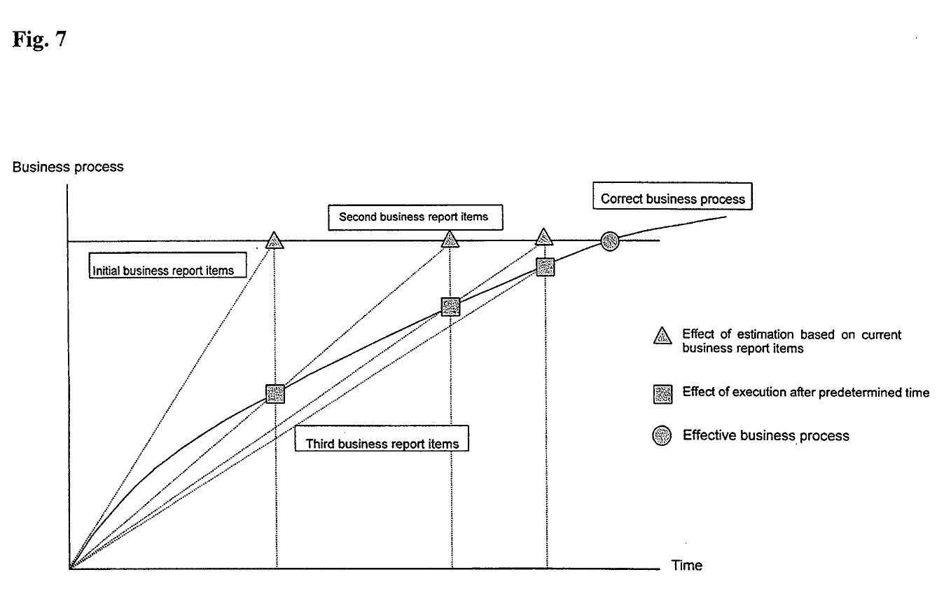

The analysis means 5, based on the business report of the responsible employee registered in the communication sheet data base 10, analyzes the correlation between the business achievement and each business report item and the utilization rate of the business report item by the responsible employee, and displays the result of analysis at the superior's terminal 12 or the responsible employee's terminal 11. An example of the result of analysis is shown in FIGS. 5 and 6. The superior checks the result of analysis, and (selectively) sets the business report items of the communication sheet displayed in each business process of each business type through the communication sheet setting means 3. Specifically, the correlation between the business report items of successful employees and those of the other employees is analyzed, and the business report items are changed accordingly (i.e. the business report items are changed to those deeply correlated with the business achievement). In this way, all the responsible employees can be caused to substantially emulate the way of doing the business of the successful employees. This process is schematically shown in FIG. 7.

The analysis means 5 analyzes the business type and the business process based on the business reports registered in the communication sheet data base 10, and clarifies the business success pattern as to what kind of product has been ordered from which customer (the party with which the particular responsible employee transacts) at what timing in collaboration with whom. The result of analysis is compiled as a rule and registered in the rule data base 9. Not only the business success pattern but also the business failure pattern are preferably registered as required.

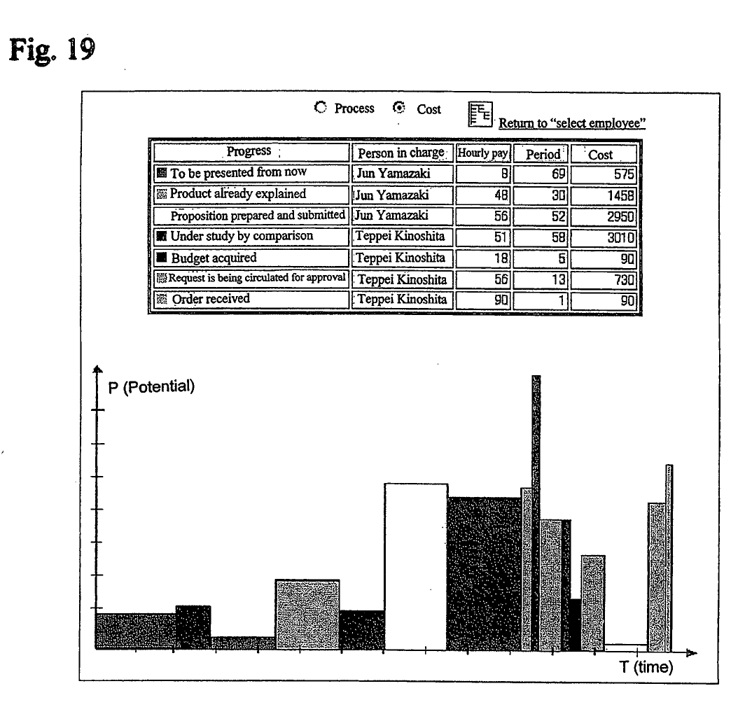

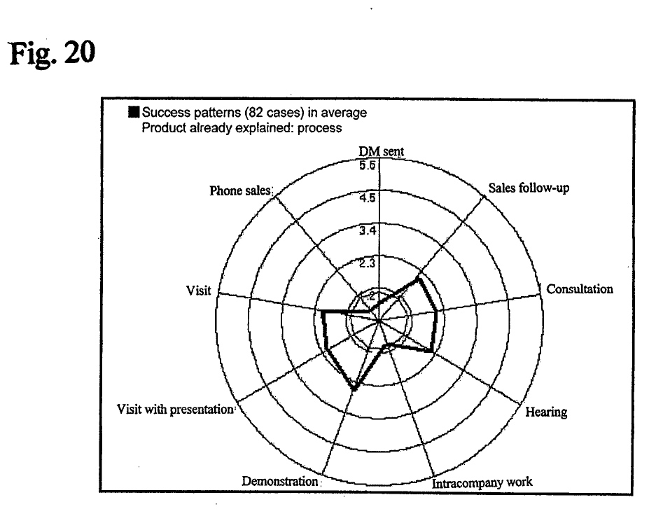

Further, the analysis means 5 may calculate and form a graph of the potential of each business process. The “potential” is defined as the period or cost calculated in terms of the product of man power and time. In this way, the cost and the time consumed in the business processes including a case of a success pattern and a case of a failure pattern can be grasped, thereby making it possible to find a policy about how much human resources should be invested in which process. This process is shown in FIG. 19. Also, the specific activities in each business process are shown graphically as a radar chart, so that the specifics of each activity of the success pattern and the failure pattern can be grasped. This process is shown in FIG. 20.

The analysis means 5 may analyze the rule on the temporal relation between the success pattern and the failure pattern, and register the rule in the rule data base 9. In the case where many responsible employees in the success pattern spend two hours on “the hearing”, for example, the analysis shows that “two hours” is an efficient length of the business process and registers it as a rule in the rule data base 9.

The rule check means 7 checks the business report stored in the communication sheet data base 10 based on the rule stored in the rule data base 9, and in the case where certain conditions are met, executes the process in accordance with the particular rule. Assume that a temporal restriction is set by a responsible employee A to register the business report before 16:00, April 1 as a rule, for example, and that the business report of the responsible employee A is not registered in the communication sheet data base 10 after the lapse of 16:00, April 1. The fact is notified to the particular responsible employee or his/her superior's terminal 12. Also, assume that a responsible employee B is engaged in “the market development” work and has registered the business report of “the proposal” after the hearing of only 30 minutes, in spite of the stipulation of the rule on the market development (i.e. the trend (correlation, etc.) of the business success pattern prepared by the analysis means 5) that the hearing should last for two hours. Then, the responsible employee B who has made the particular business report is informed that two hours or longer should be spent on the hearing to succeed in the business.

In this way, while a responsible employee or a superior makes a decision on the business method with reference to the business record or the like as in the prior art, the responsible employee can be requested to correct the way of conducting the business based on the business report of another successful employee. Further, the temporal restriction (a specific date by which a report should be submitted, for example) on the business report or the like which is liable to be forgotten can be notified to enlighten the responsible employee.

The responsible employee data base 8 is the one in which the responsible employee's information received by the responsible employee registration means 2 is registered. The responsible employee information in registration preferably include the name of the responsible employee, the responsible employee's code, department, department code, electronic mail address, etc.

The rule data base 9 is the one in which the temporal restriction received from the temporal restriction registration means 4 and the rule prepared by the analysis means 5 are registered. The rule in registration preferably includes the trend (correlationship) of the business success pattern of a successful employee and the business failure pattern as well as the temporal restriction set by the responsible employee or the superior.

The communication sheet data base 10 is the one in which the business report from the responsible employee is registered. The business report is preferably registered for each business report item and each business process of the business type. Also, the business report is preferably in selected one of the forms predetermined for standardization.

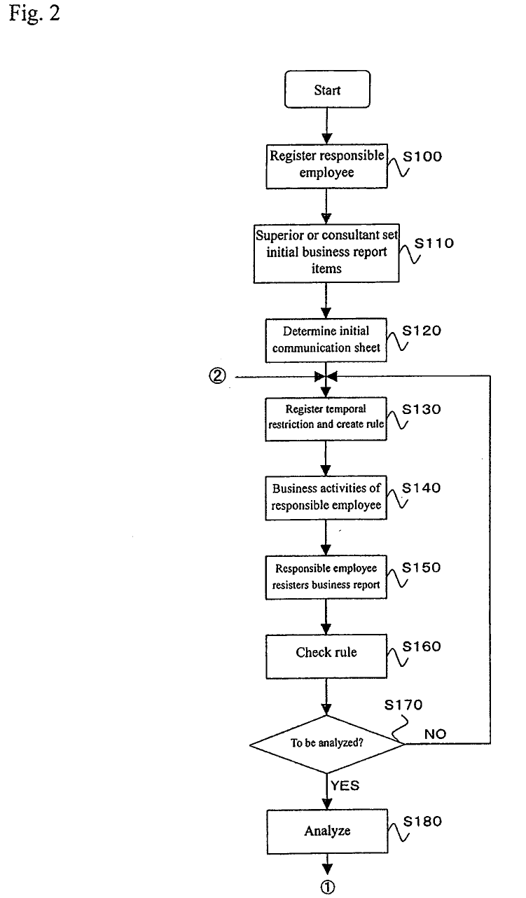

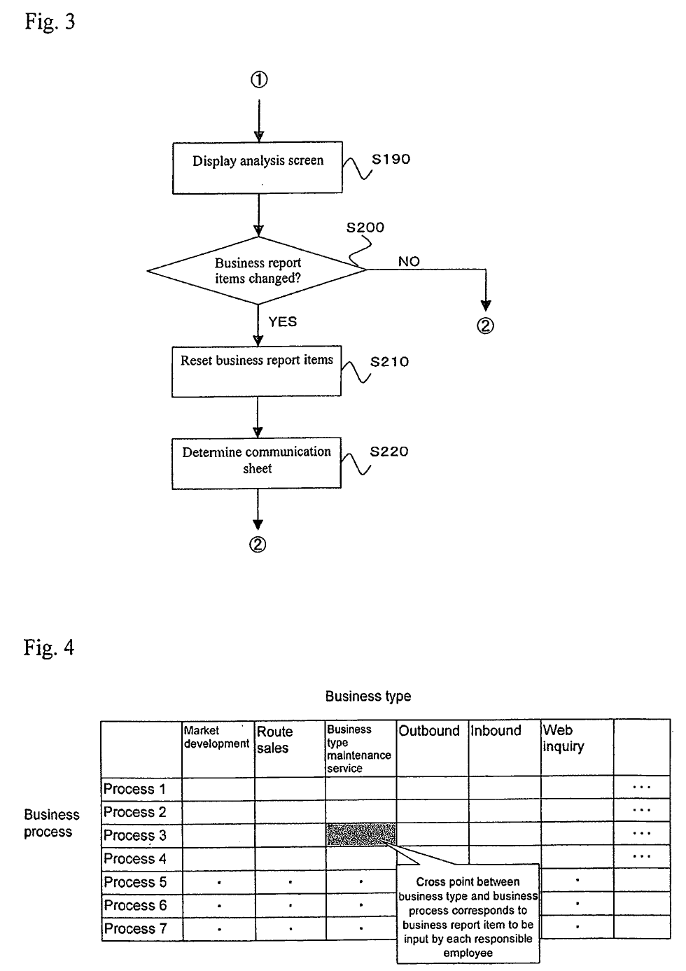

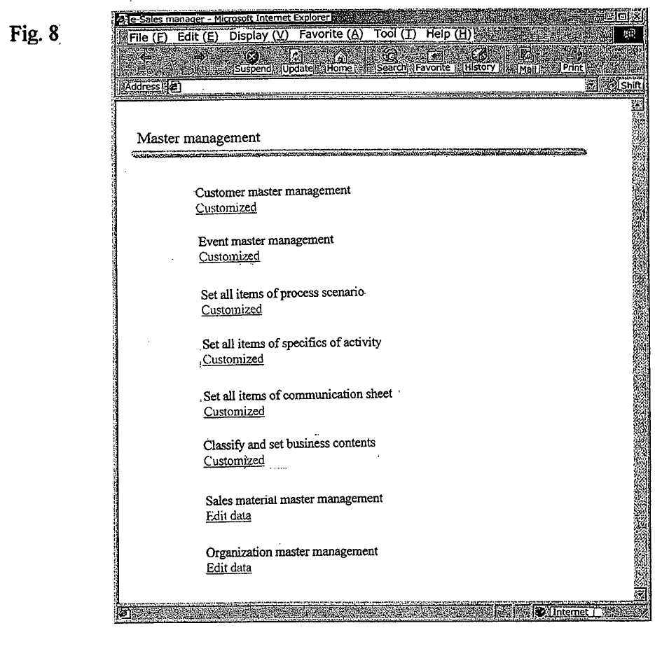

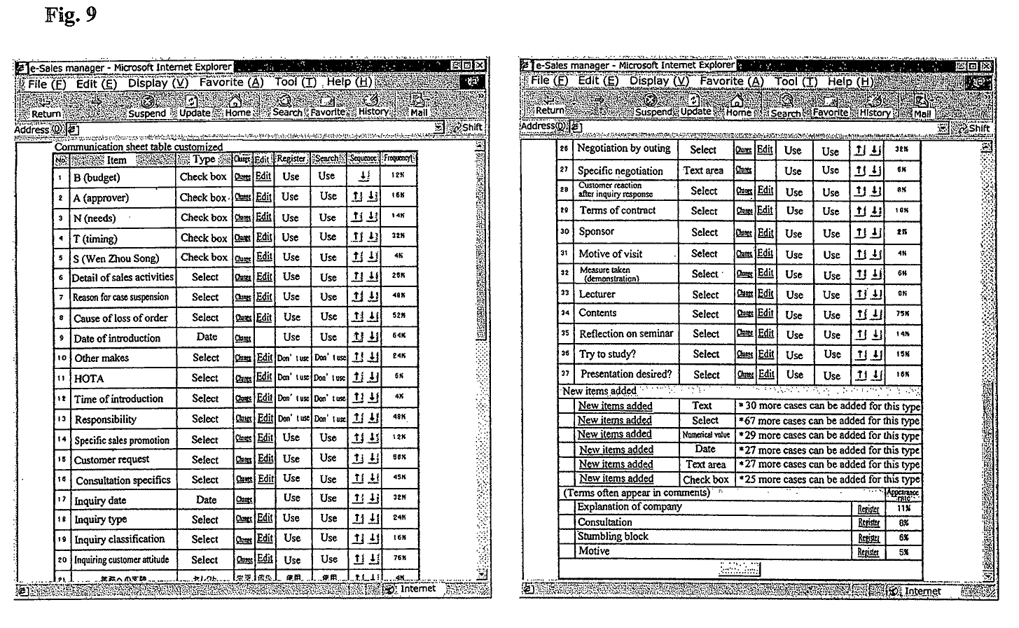

Next, an example of the process flow according to this invention is explained in detail with reference to the flowcharts of FIGS. 2 and 3. To utilize the system 1 for autonomously improving the business process according to the invention, the information on the responsible employee conducting the business is input by the particular employee or the superior from the responsible employee's terminal 11 and/or the superior's terminal 12, received by the responsible employee registration means 2 through the network 13 and registered in the responsible employee data base 8 (S100). In registering the responsible employee's information, the “organization master management” is selected from the master management screen shown in FIG. 8.

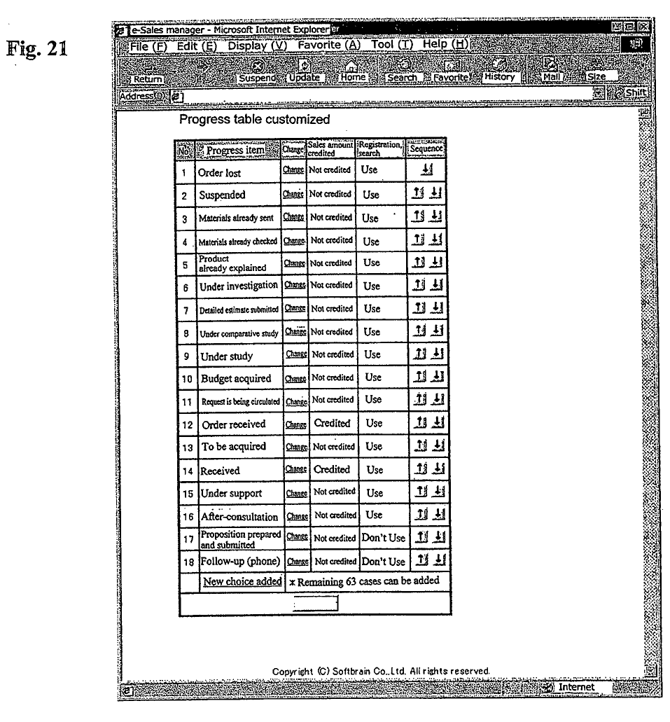

After registration of the responsible employee, all the cases handled by the whole company classified in temporal phases, i.e. the business process is registered from the superior's terminal 12 through the communication sheet setting means 3. This registration is made from the business process table registration screen shown in FIG. 21 by selecting the “setting all items of process scenario” on the master management screen shown in FIG. 8.

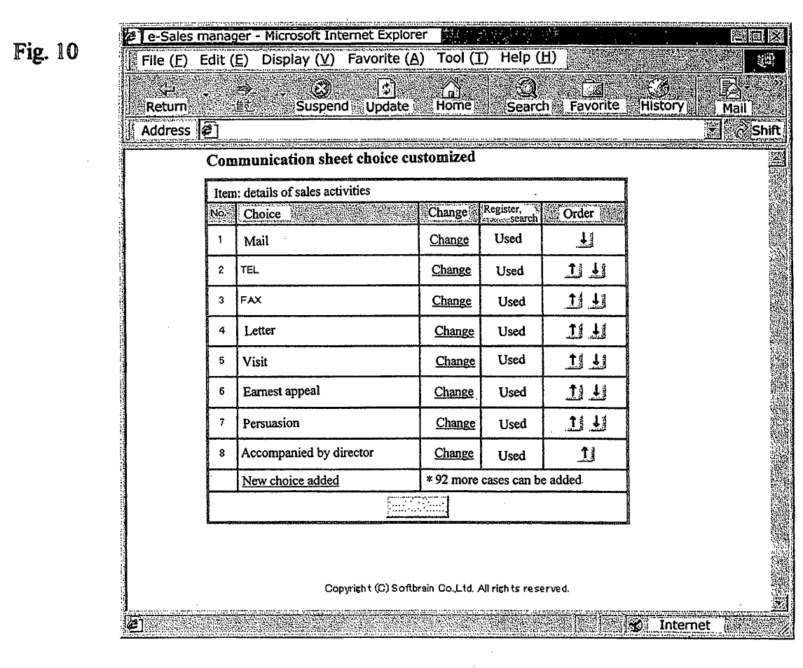

Next, the specific business activity of the responsible employee is set by selecting “setting all items of specific activity” on the master management screen shown in FIG. 8 and displaying the pull-down menu customized screen of FIG. 10. As a result, the specific activities of the business report items can be selected by the responsible employee as a pull-down menu. FIG. 10 shows an example of the pull-down menu customized screen.

After registration of the business process and the specific activities, the superior sets through the superior's terminal 12 the business report items to be reported (registered) in the communication sheet by the responsible employee (S110), which business report items are received by the communication sheet setting means 3 and registered in the communication sheet data base 10.

The “setting all communication sheet items” on the master management screen shown in FIG. 8 is selected, and the business report item list screen shown in FIG. 9 is displayed. This screen is a list of the business report items registered by each responsible employee, and used to select a business report item to be included in the communication sheet or to add a new business report item. In other words, the business report items used for the whole system 1 to autonomously improve the business process are set from the business report item list screen.

The word “type” used herein is defined as the manner in which a given business report item is displayed on the communication sheet, “select” is to select from the pull-down menu, “check box” to check a check box, “date” to select (input) the date, and “text area” to a text input. In the case where it is desired to re-edit the pull-down menu of the “detailed contract-signing activity” constituting the sixth business report item in FIG. 9, for example, FIG. 10 is displayed by a predetermined operation, so that a new choice can be added, the order of display on the pull-down menu is changed (vertically changed by selecting the arrow of the sequence button), and in the case of non-use, the non-use can be selected.

After setting the business report item list screen, the business type of the responsible employee is set. The “business type” is defined as the type or method of business of each responsible employee including the market development, route sales, maintenance service, outbound and inbound communication and Web inquiry.

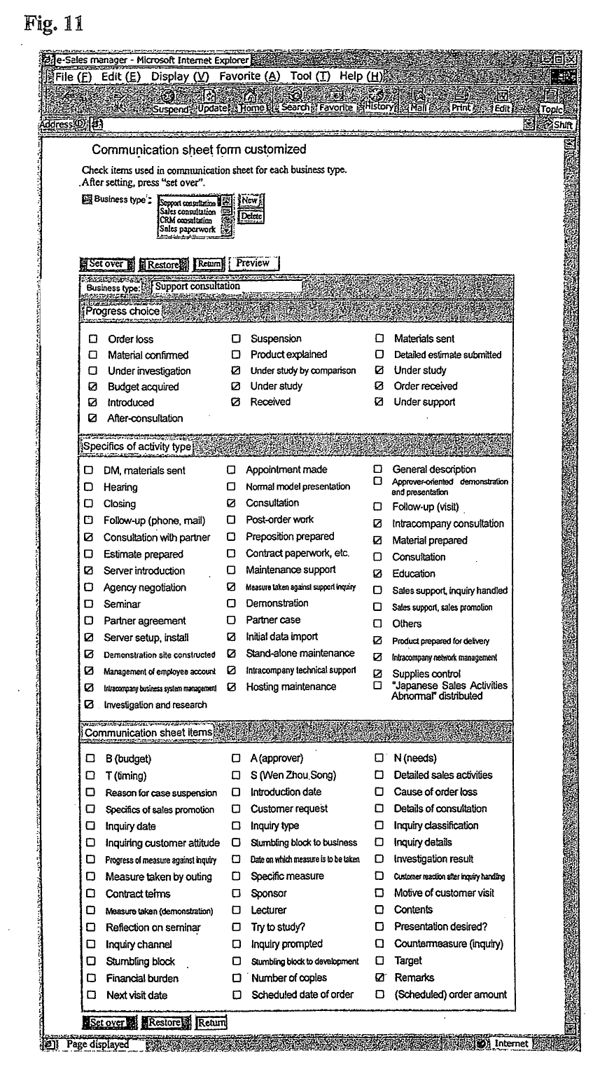

After setting the business type, the “change” of the business report item in FIG. 9 or the “change” in FIG. 10 is selected, and a business report item to be displayed for each business process of each business type is set from the business report item display select screen of FIG. 11. On the business report item display select screen, the business type shown in the schematic diagram of FIG. 4 is selected from “the business type” in FIG. 10, and a business report item and a business process required for the particular business type are selected.

In the case where the “support consultation” is selected as a business type, for example, a business report item and a business process required in the case where the business type is the support consultation are selected. The business report item is selected from the “specific activity choices”, and the business process from the “progress choices”.

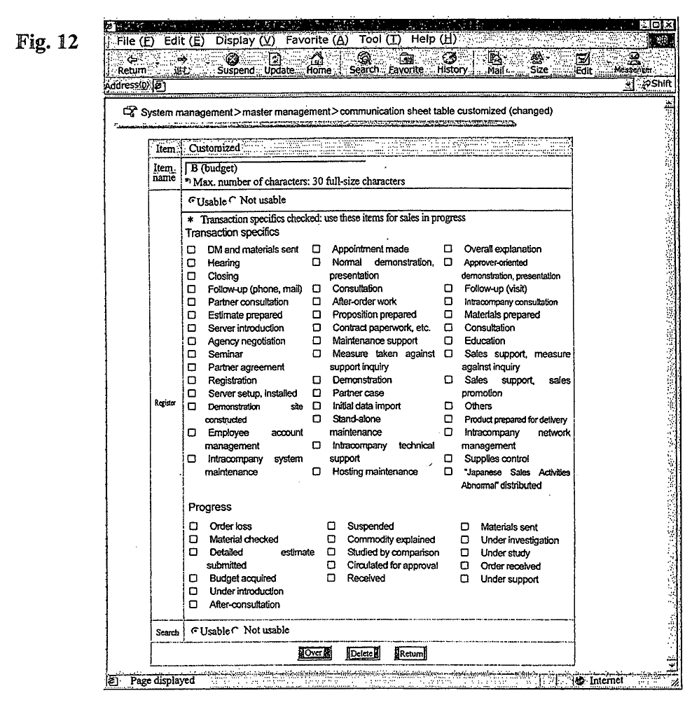

In FIG. 11, after setting the business report item display select screen, the business report item detail setting screen is displayed and set by a predetermined operation to set a business process and an associated business report item to be displayed. FIG. 12 shows an example of the business report item detail setting screen. The setting carried out in FIG. 11 is not more than to select the business report item and the business process required for the business type, and under this condition, the business report item not required for a given business process may be displayed on the communication sheet. This display causes an erroneous input and erroneous analysis. Therefore, a business process in which a given business report item is to be displayed is set from the business report item detail setting screen of FIG. 12.

In the example of the business report item detail setting screen shown in FIG. 12, assume that the business type is “support consultation” and “B (budget)” is selected as a business report item in FIG. 12 (i.e. the check box of “B (budget)” is selected in the “specific activity choice” in FIG. 11). Then, “B (budget)” is displayed as the item name (name of the business report item) in FIG. 12, and a list of “contents of business talks” and “the progress” (business process) is displayed. Thus, the superior selects the “progress” (business process) for which “B (budget)” is desirably displayed as a business report item and the specifics of the business talks desirably displayed as the “specifics of business talks” to be selected by the responsible employee in the process. In the case where “under investigation” is selected as the “progress” (business process) and the “estimate prepared” is selected as the “specifics of business talks”, for example, the “B (budget)” of the business report item is displayed only in the case where the “process condition” (business process) is “under investigation”. In that case, the “estimate prepared” is displayed as the “specifics of business talks”.

As described above, the superior sets the business report item to be displayed in the business process of each business type, and in this way, the initial communication sheet is determined (S120). An example of the communication sheet determined as in S110 and S120 is shown in FIG. 13. FIG. 14 shows an example of the communication sheet used in the case where the responsible employee inputs the business report with a mobile phone having the network function.

After determining the initial communication sheet, the analysis means 5 analyzes the business type and the business process based on the business report registered in the communication sheet data base 10. At the same time, the business success pattern (or the business failure pattern) is analyzed as to what kind of product has been ordered in what way from which customer (the other party of transactions by the responsible employee) at what timing in collaboration with whom, then, these facts are registered as a rule in the rule data base 9 (S130).

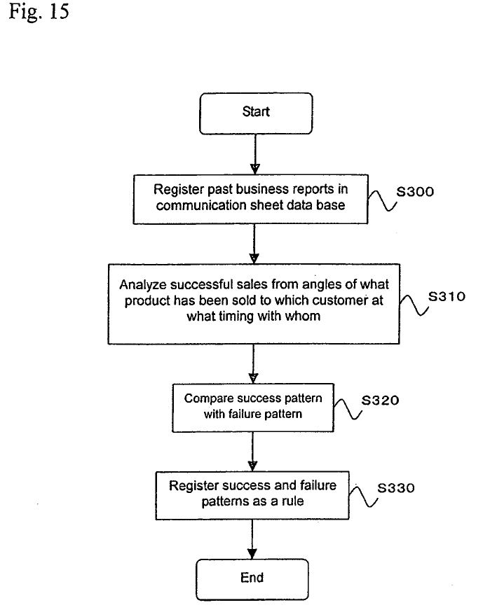

A flowchart showing an example of the process flow for the analysis means 5 to prepare a rule in S130 is shown in FIG. 15. The superior or the like standardizes the past business reports using the business report items equivalent to the communication sheet determined in S130, and registers them in the communication sheet data base 10 (S300). According to this embodiment, the standardized business report items, which are registered in the communication data base 10, may of course be registered in another data base with equal effect.

From the viewpoint of the business type and the business process, the business report items registered in the communication sheet data base 10 are analyzed by the analysis means 5 as to what product has been ordered from which customer in what way at what timing in collaboration with whom (S310). This analysis is made possible by standardization in S300 with the business report items equivalent to those in S130.

As the result of analysis in S310, the analysis means 5 compares the business success pattern (which has led to an order) with the failure pattern (which has failed to lead to an order) (S320), and the success pattern (failure pattern) is registered as a rule in the rule data base 9 (S330). By the process of steps S300 to S330, the business success pattern (failure pattern) is accumulated.

In this analysis, as described above, the potential is calculated in the manner shown in FIG. 19 and used as a standard. As an alternative, as shown in FIG. 20, the specifics of the activities are analyzed and displayed.

Specifically, in a simply computerized business report, the items are input only as a text as desired by the responsible employee. An attempt to analyze the specifics of the activities from the business report thus input makes it necessary to analyze, by a well-known method, the sentences of the business report items input as a text. Thus, the problem of the accuracy of sentence analysis and the processing time is posed. By standardizing the business report items of the communication sheet (business report input screen) by the pull-down menu and check boxes as in this invention, however, the business report items can be easily digitized. Unlike in the prior art, therefore, the analysis of the sentences is not required, and the erroneous determination of the sentence analysis is eliminated, thereby making possible the analysis with high accuracy.

The analysis means 5 also analyzes the rule on the temporal relation between the success pattern and the failure pattern, and the result is registered as a rule in the rule data base 9 (S130). In the case where many responsible employees in the success pattern spend two hours in the “hearing”, for example, the analysis shows that “two hours” is an appropriate time period for an efficient business process of “hearing”, which is registered as a rule in the rule data base 9. In the case where more employees come to spend three hours in “hearing” as a success pattern, the rule is of course changed and registered accordingly.

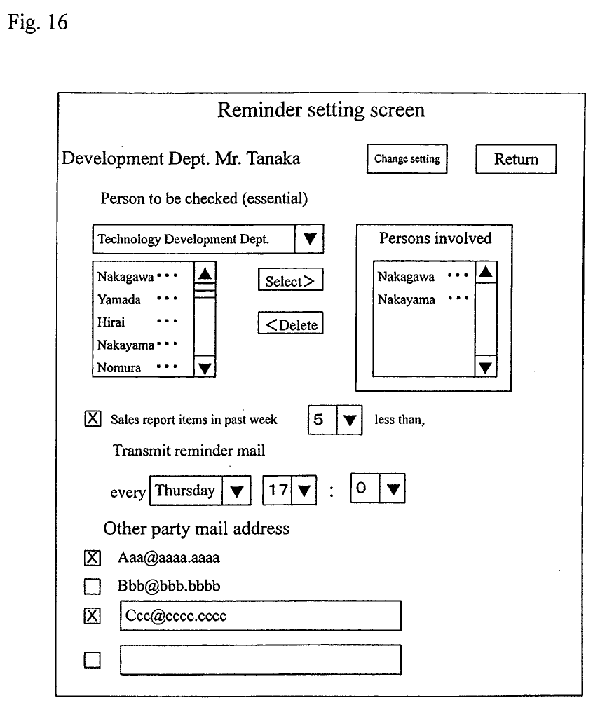

In S130, the temporal restriction (time limit) for the responsible employee or the superior as well as the business success and/or failure pattern may be registered. This function is what is called a reminder as to the requirement that a predetermined business report should be registered by a predetermined date and time. A complicated business report can thus be positively registered without fail. FIG. 16 shows an example of a reminder setting screen. The reminder setting screen shown in FIG. 16 is an example for notifying as a reminder in the case where less than a predetermined number of the business report items are registered during a predetermined period. In this case, the notification is preferably made by electronic mail.

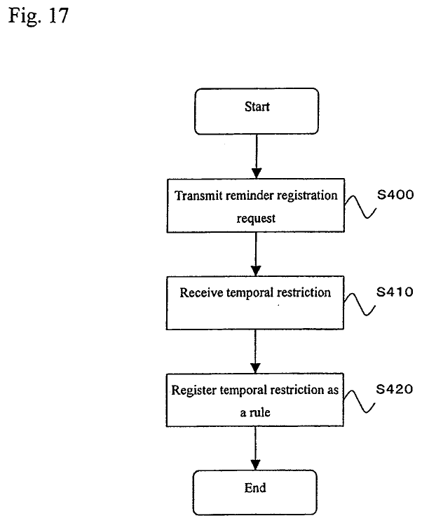

FIG. 17 is a flowchart showing an example of the process flow for registration of the temporal restriction. The superior and/or the responsible employee registering the temporal restriction accesses the business process autonomous improvement system 1 from the superior's terminal 12 or the responsible employee's terminal 11 and transmits a request for registration of the temporal restriction. Upon receipt of the registration request (S400), the temporal restriction registration means 4 transmits the reminder setting screen to the superior's terminal 12 or the responsible employee's terminal 11. The superior and/or the responsible employee inputs the required information from the screen and transmits it to the business process autonomous improvement system 1. The temporal restriction, after being received by the temporal restriction registration means 4 (S410), is registered in the rule data base 9 (S420).

After the rule is prepared and the temporal restriction is registered in S130 (step S130 is not of course necessarily completed, but the process may be executed in parallel to S130, or in the case where the registration of the temporal restriction is not changed, the registration process is not required), the responsible employee conducts the business activities in the same way as in the past (S140).

After the business activities or at regular time intervals, the responsible employee accesses the business process autonomous improvement system 1 from the responsible employee's terminal 11 and sends a request to transmit the communication sheet. The communication sheet registration means 6, upon receipt of the transmission request, sends the communication sheet shown in FIG. 13 or 14 to the responsible employee's terminal 11. In the case where the responsible employee's terminal 11 is a personal computer, preferably, the communication sheet shown in FIG. 13 is transmitted, while in the case where the responsible employee's terminal 11 is a mobile phone having the network function, the communication sheet shown in FIG. 14 is transmitted.

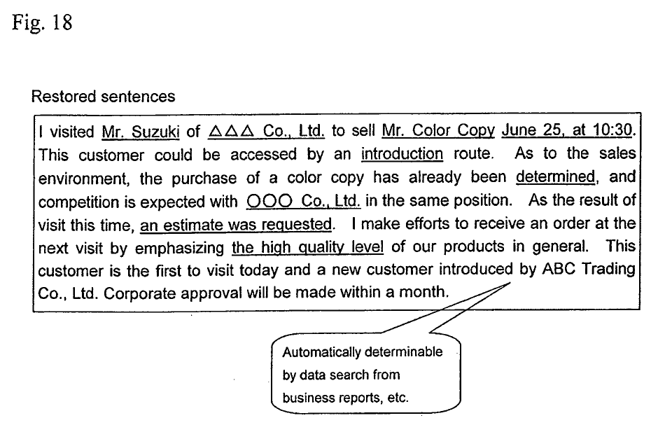

Upon receipt of the communication sheet through the responsible employee's terminal 11, the responsible employee inputs the business report items from the communication sheet and transmits it to the business process autonomous improvement system 1. The communication sheet registration means 6, upon receipt of the business report with the business report items input therein, registers it in the communication sheet data base 10 (S150). As a result, the business report has been submitted by the responsible employee. The business report submitted by the responsible employee, though standardized with a pull-down menu, etc., may also include non-standardized business report items such as a comment. After registration of the business report in the communication sheet shown in FIG. 14, ordinary sentences can be restored as shown in FIG. 18 by complementing the auxiliary verbs and the postpositional words functioning as an auxiliary to main words. The superior checking the business report, therefore, can read the business report in the same way as the conventional business record.

Specifically, the business report, though input as a standardized communication sheet, is read by the superior as ordinary sentences as shown in FIG. 18. Since the business report is standardized, however, dual advantages including the ease with which the analysis is easily made can be secured.

After registration of the business report in the communication sheet data base 10 in S150, as described above, the rule check means 7 checks the temporal restriction and the business success pattern and the failure pattern stored in the rule data base (S160). According to this embodiment, the rule is checked of course after the business report. Nevertheless, the rule may be checked in any stage.

In checking the business report with the business success pattern, assume that the responsible employee B conducts the “market development efforts” and after the “hearing” for only 30 minutes, has registered the business report of a “proposal”, while the market development rule (i.e. the trend (correlation, etc.) of the business success pattern prepared by the analysis means 5) stipulates the “hearing” of two hours. The particular employee B who has submitted the business report is informed that the chance of success is made higher by spending at least two hours on the “hearing”.

Based on the temporal restriction registered in S130, the rule check means 7 determines the temporal restriction according to the rule data base 9. In the case where the temporal restriction is satisfied, a predetermined reminder is transmitted to the superior's terminal 12 and/or the responsible employee's terminal 11 by electronic mail or the like. The electronic mail thus transmitted is received and checked by the superior's terminal 12 and/or the responsible employee's terminal 11. Thus, the superior and/or the responsible employee reconfirms the temporal restriction. According to the process flow described above, the superior and/or the responsible employee is prevented from forgetting the temporal restriction.

In this way, the responsible employee, after the business activities, repeatedly submits the standardized business report from the communication sheet in the same manner as the conventional business record (i.e. S130 to S160 are repeatedly executed)(S170).

In analyzing the business of the responsible employee, the superior transmits an analysis request to the analysis means 5 from the superior's terminal 12 (S170). The analysis means 5 that has received the analysis request makes analysis based on the standardized business report registered in the communication sheet data base 10 (S180). In conducting the analysis, preferably, the correlation between the number of interviews and the successful order received, for example, is calculated, or otherwise, the business trend for each responsible employee or between responsible employees are analyzed. The analysis result is displayed as an analysis screen as shown in FIG. 5 in the form of scatter diagram to indicate the business method for each responsible employee. As shown in FIG. 6, on the other hand, the business trend of the responsible employee is displayed as a radar chart (S190). These graphs may be displayed at the same time to enable the superior to check by comparison.

In the case where the superior, checking the analysis screen, resets the business report items of the communication sheet to correct a responsible employee to introduce the business method of another successful employee, the superior accesses the communication sheet setting means 3 of the business process autonomous improvement system 1 from the superior's terminal 12 and selects the “table customized” of the “business report master management” from the master management screen (FIG. 8). In this way, the business report items are reset through the communication sheet setting means 3 as in the case of S110 (S210). Specifically, based on the result of analysis in S180 and S190, the highly correlated business report items, i.e. the business report items used often by the successful employees are set as business report items for all the responsible employees. In this way, the particular business report items can be reflected in those of the whole responsible employees and the business method can be corrected as shown in FIG. 7 (a virtually correct business process is approached by correcting the initial business report items as second ones). This resetting of the business report items is repeated a plurality of times, so that the virtually correct business process is steadily approached while at the same time making it possible to constantly follow the ever-changing correct business process for an improved business efficiency.

The business according to this invention of course includes those conducted as required in the departments of general affairs, finance and legal affairs as well as the sales department.

The functions of each means and data base according to the invention are classified only logically and may belong to the same physical or factual area. Also, instead of the data base, the data file may of course be used, and the expression “data base” includes the data file.

In carrying out the invention, a storage medium having recorded thereon the program of software for realizing the functions of the embodiments thereof is naturally supplied to the system so that the system computer reads and executes the program stored in the storage medium.

In this case, the program itself read from the storage medium realizes the functions of the embodiments described above, and the storage medium storing the program of course makes up the invention.

The storage media for supplying the program used for the above-mentioned purpose may include a magnetic disk, a hard disk, an optical disk, a magnetooptic disk, a magnetic tape, a nonvolatile memory card and the like.

By executing the program read by the computer, the above-mentioned functions of the embodiments are realized as described above. In addition, based on the program instruction, the operating system of the computer performs a part or the whole of the actual process, whereby the functions of the embodiments described above are realized.

Further, the program read from the storage medium is written in the volatile or nonvolatile storage means of the function expansion unit connected to the computer or the function expansion board inserted in the computer, after which in response to the instruction of the particular program, the arithmetic processing unit or the like of the function expansion board or the function expansion unit performs a part or the whole of the actual process, whereby the functions of the embodiments described above are realized.

### INDUSTRIAL APPLICABILITY

According to this invention, there is provided a system for autonomously improving the business process, in which the business report items of all the responsible employees are dynamically changed in accordance with the business activities of successful employees.

Specifically, to change the report items in the business report leads to the requirement on the part of the responsible employees to conduct the business activities relating to the report items, so that the business activities of all the responsible employees converge to those of successful employees.

Further, the business report items are standardized as a pull-down menu or a check list, and therefore the process of the business activities can be digitized. Thus, the analysis as to which report items should be selectively discarded or adopted can be automatically carried out.

1. A system for autonomously improving the business process to support the business activities of a responsible employee, characterized in that the data can be transmitted and received between a responsible employee's terminal owned by the responsible employee and a superior's terminal owned by a superior through a network, the system comprising:
a communication sheet setting means for causing the business report items in the communication sheet displayed at the responsible employee's terminal to be set from one of the responsible employee's terminal and/or the superior's terminal and registered in a communication sheet data base; and
a communication sheet registration means for displaying the communication sheet at the responsible employee's terminal, receiving a business report from the responsible employee's terminal and registering the business report in the communication sheet data base.

2. A system for autonomously improving the business process as described in claim 1,
characterized in that said communication sheet setting means includes at least selected one or all of means for setting the specifics of the business activities, the business report items, the business type and the business report item to be displayed for each business process for each business type.

3. A system for autonomously improving the business process as described in claim 1, characterized by further comprising an analysis means for analyzing selected one of the whole, an arbitrary group and the responsible employee engaged in the business based on the business report registered in the communication sheet data base.

4. A system for autonomously improving the business process as described in claim 1,
characterized in that the business pattern is analyzed based on the registered business report thereby to create and register a rule.

5. A system for autonomously improving the business process as described in claim 1, characterized by further comprising a temporal restriction registration means for receiving the temporal restriction on the business report from the responsible employee's terminal and/or the superior's terminal and registering the temporal restriction in the rule data base.

6. A system for autonomously improving the business process as described in claim 1, characterized by further comprising a rule check means for checking the business report registered in the communication sheet data base based on the registered rule, and notifying the responsible employee's terminal and/or the superior's terminal in the case where certain conditions are satisfied.

7. A system for autonomously improving the business process as described in claim 1,
characterized in that the communication sheet or the business report items are provided for each business type in the business activities and each business process for the business type.

8. A method for autonomously improving the business process to support the business activities of the responsible employee, wherein the data can be transmitted and received between a responsible employee's terminal of the responsible employee and a superior's terminal of the superior through a network,
characterized in that the business report items in the communication sheet displayed at the responsible employee's terminal are set and registered in the communication sheet data base from the superior's terminal and/or the responsible employee's terminal, and
the communication sheet is displayed at the responsible employee's terminal, and the business report is received from the responsible employee's terminal and registered in the communication sheet data base.

9. A method for autonomously improving the business process as described in claim 8,
characterized in that the business report items of said communication sheet are set while at the same time setting at least selected one or all of the business process, the specifics of the business activities, the business report items, the business type and the business report item to be displayed for each business process for each business type.

10. A method for autonomously improving the business process as described in claim 8,
characterized in that selected one of the whole, an arbitrary group and the responsible employee conducting the business based on the business report registered in the communication sheet data base is analyzed.

11. A method for autonomously improving the business process as described in claim 8,
characterized in that the business pattern is analyzed based on the registered business report, and a rule is created and registered.

12. A method for autonomously improving the business process as described in claim 8,
characterized in that the temporal restriction on the business report is received from the responsible employee's terminal and/or the superior's terminal and registered in the rule data base.

13. A method for autonomously improving the business process as described in claim 8,
characterized in that the business report registered in the communication sheet data base is checked based on the registered rule, and
in the case where certain conditions are satisfied, the responsible employee's terminal and/or the superior's terminal is notified.

14. A method for autonomously improving the business process as described in claim 8,
characterized in that the communication sheet or the business report items are provided for each business type in the business activities and each business process of the business type.
